(19) United States
(12) Patent Application Publication
(10) Pub. No.: US 2026/0349593 A1
(43) Pub. Date: Nov. 5, 2026

(54) USE OF INHERITANCE IN SELECTING AND ORGANIZING DATA AND PROGRAMS FOR ARTIFICIAL INTELLIGENCE MODEL QUERIES

(71) Applicant: Steven Ganz, Chicago, IL (US)

(72) Inventor: Steven Ganz, Chicago, IL (US)

(73) Assignee: Teamifier, Inc., Chicago, IL (US)

(21) Appl. No.: 19/741,950

(22) Filed: Jul. 15, 2026

Related U.S. Application Data
(63) Continuation-in-part of application No. 18/611,655, filed on Mar. 20, 2024.
Application No. 18/611,655 is a continuation of application No. 17/448,748, filed on Sep. 24, 2021, now Pat. No. 11,989,170.

(51) Int. Cl. G06F 3/04845; G06F 16/23; H04L 65/403; H04L 67/10

(52) U.S. Cl. CPC G06F 3/04845; G06F 16/2358; H04L 65/403; H04L 67/10

(57) ABSTRACT

Methods and apparatuses are provided for utilizing the reconfiguration of a directed graph structure to control for relevance the information provided to aid an artificial intelligence model in resolving queries, for automating construction of the directed graph, and for training the model.

### CROSS-REFERENCE TO RELATED APPLICATIONS

The present application is a continuation-in-part of U.S. Nonprovisional patent application Ser. No. 18/611,655, filed Mar. 20, 2024, currently pending, and which is hereby incorporated by reference herein; which is a continuation of U.S. Pat. No. 11,989,170, filed Sep. 24, 2021; which is a continuation of U.S. Pat. No. 11,222,074, filed Nov. 25, 2016; which claims the benefit of U.S. Provisional Patent Application Ser. No. 62/260,072, filed Nov. 25, 2015 and which is hereby incorporated by reference herein.

### BACKGROUND

A model in artificial intelligence is a simplified mathematical or computational representation of a real-world system that is trained on data to understand patterns, allowing tasks such as classification, prediction, transformation, and generation to be performed.

Modern generative artificial intelligence systems commonly operate by distinguishing a prior training phase, leading to static model applicable to multiple users, and an inference phase, during which that model is applied to a particular situation and request, leading to generation of a response. The local information available to the latter phase is called a context window. The context window generally includes the output generated by the request. More precisely for the case of an attention mechanism, during response generation, the context window is the locally available information that can be referenced in taking the next incremental generative step. Multi-head attention allows for multiple context windows to together cover non-contiguous portions of the local information in taking that incremental generative step, potentially leveraging important relationships rather than simply transforming each part of the input to a corresponding part of the output. For language models, the context window is generally structured as and measured in terms of tokens, each token representing some form of a semantic primitive.

The size and contents of the context window is crucial to efficient, relevant, and correct output generation. Other generative artificial intelligence approaches, including those that learn online in real-time and those that operate over more structured information, also need to be concerned with the structure and content of information used in generating output in response to particular requests.

The context window is a valuable resource. Architectures may restrict to a finite amount context window space. The more information that can be crammed into the context, the more that is potentially available to process requests. Conversely, insufficient information in the context window would clearly have a negative impact on model performance by omitting potentially relevant information from consideration. Furthermore, there are other demands on context space. Stateless models can only maintain a conversational interface by including prior interactions explicitly in processing subsequent ones. Retrieval-oriented generation (RAG) consists of loading up context information, beyond the immediate prompt or conversation. This is often used to incorporate similar information to that upon which the model was trained but more recent, but it can also be used to incorporate information relevant to an enterprise.

But there are also disadvantages to maintaining a large context window. The first is efficiency. A larger context window requires both more memory and more computation. Another is that the impact of the most relevant information in a large context window may be diluted by red herrings that throw the model of track, providing a source of hallucinations.

There is widespread recognition of the importance of context management.

From CNN Business, Lisa Eadicicco, “Nvidia just laid out what's next for the tech that made it the world's most valuable company”, <https://www.cnn.com/2026/01/05/tech/vera-rubin-nvidia-ai-ces>, 1/5/2026: “The bottleneck is shifting from compute to context management. To scale, storage can no longer be an afterthought. As inference scales to giga-scale, context becomes a first-class data type.” -NVIDIA Senior Director of AI Infrastructure, Dion Harris

From AI Engineer, Paolo Perrone, “What Is RAG (Retrieval-Augmented Generation)?”, <https://theaiengineer.substack.com/p/what-is-rag-retrieval-augmented-generation>, 3/3/2026: “AI chatbots hallucinate 3% to 27% of the time, even in setups designed to prevent it. The retrieval matters more than the generation. What makes or breaks it is the retrieval: how you chunk your docs, how you search them, and whether the right context actually lands in the prompt.”

Although much of this architecture was originally motivated by use cases such as translating documents between natural languages, the demands on generative AI models are now more likely to include inquiries about entities that may be organized in a hierarchical structure, such as solutions to problems. Code generation is widely recognized as an important specialty in generative artificial intelligence.

Following is a summarization of previously disclosed material. Details may be found in the referenced application. Previously disclosed material may also be summarized in the following sections of this application.

Previous disclosures included a methodology for restructuring a tree or, more generally, a DAG, with some associations representing refinement relations, by inheriting entities descended from refinement ancestors through refinement associations to descend from refinement descendants (a converse restructuring is also disclosed). Note that as previously disclosed, inheritance of descendants stops with any entity already descended from a locus entity to which it was inherited, that entity remaining a child of the last inherited descendant(s). A motivating example is a network of interrelated problems and solutions. The associations include refinement, which in various embodiments may take the form of specialization for problems or elaboration for solutions. The restructuring involves inheriting portions of a global DAG through a refinement relation to locus entities of particular interest, such as inheritance of a structured solutions to a more general problem by a more specific problem, producing a localized DAG. It should be noted that what is referred to as context here, with respect to a context window, subsumes both the context and substructure of the previously disclosed inventions. The intended meaning of the word “context” herein will be made clear from the context.

It was also previously disclosed that chains of entities that had been inherited within a localized DAG may be restated for relevance to the locus entities, the new entities being refinements in the global DAG of each corresponding inheritable entity and also being related among themselves by associations corresponding to those of the inheritable entities. For various embodiments, restatement replaces inherited nodes indicating inheritable entities with nodes indicating restated entities.

Methods of associating code with solutions were also previously disclosed. In particular, solutions may be associated with branches in a repository or with classes or methods of object-oriented programs.

Various other entity types including users, skills, projects, and various relationships among those were previously disclosed as were various modeling constructs, code, and other forms of auxiliary information that might be associated with entities of various kinds.

Code generation has become a common use of artificial intelligence models.

Where a model is trained to respond to queries on the basis of relevant information, it is common to augment that system with a conversational thread comprising a sequence of user prompts and model responses, augmented with each subsequent user prompt, and portions of which are made to feed back into the model with each subsequent user prompt.

Where the user prompts and model responses relate to solutions to problems and various modeling constructs, code, and other forms of auxiliary information, the system can be further augmented or otherwise modified by leveraging previously disclosed inventions.

### SUMMARY

This exposition assumes definitions as in previously disclosed work. This exposition assumes an expansive view of entities; in particular, projects may themselves be considered to be entities. This exposition assumes the mathematical definition of DAGs, which requires neither that they be connected nor that they contain merge points, unless specifically indicated otherwise. This exposition assumes, without loss of generality, the convention that associations are considered to point upward in any DAG, from refining to refined entities, and from inheritable entities to the common refinement ancestor from which they may be inherited by a locus entity, for example from a solution to a problem it solves and from a problem to a solution that it decomposes.

If a model stores information about a space of interrelated entities and is presented with a query about a particular entity in that space, or several such entities, it is possible to craft a context window that includes specifically chosen information from that space. In particular, if the space represents refinement relationships, the previously disclosed inheritance reconfiguration yields precisely the information that ought to be provided to the model to process those queries. This may include solutions (and their descendants) inherited by a locus problem through a chain of problem specialization associations and it may include problems (and their descendants) inherited by a locus solution through a chain of solution elaboration associations. For a language model, this information can be structured by merely stringing together text (possibly represented as tokens) related to the included problems and solutions. The relationships within the transformed DAG may be omitted from the context window, expressed as additional text, or under a more general notion of model, the input may be structured to represent those relationships explicitly.

If a user's goal is not merely general knowledge about a topic or about a space of problems and solutions, but rather an approach for solving a particular problem, restructuring the DAG has the advantage of making likely candidate approaches immediately available as such for inclusion in the response.

Where a model is trained to respond to queries on the basis of relevant information, it is common to augment that system with a conversational thread comprising a sequence of user prompts and model responses, augmented with each subsequent user prompt, and portions of which are made to feed back into the model with each subsequent user prompt.

Where the user prompts and model responses relate to entities supporting a refinement relation, the system can be further augmented or otherwise modified by leveraging previously disclosed inventions. When presented with familiar content, the system can reference a structured global DAG representing interrelated entities. When presented with a new refinement of a known entity, the system can, directly or through an API, adapt nonrefining descendants of the known entity to the new refining entity via inheritance or perform other operations that it was disclosed that a user might perform through various user interfaces.

In particular, the user prompts and model responses may for various embodiments relate to solutions of problems and modeling constructs (for example Boolean conditions, state machines, or Bayesian networks, as previously disclosed, or other models such as Petri nets or electric or quantum circuits), code, and other forms of auxiliary information specifying or implementing those solutions or describing ongoing activities, communications, or plans related to implementing solutions. For various embodiments, any such information would be stored in or referenceable from entities in any global DAG and nodes in any localized DAG. When presented with familiar content, the system can reference such a global DAG representing interrelated problems and solutions. When presented with a new specialization of a known problem, it can, directly or through an API, adapt general solutions of the known problem to the new specialized problem via inheritance or perform other operations that it was disclosed that a user might perform through various user interfaces.

The inheritance reconfiguration, as applied to code, would make particular candidate code blocks available to be included in generated code. It is a standard approach to pass an entire code base to a model trained to potentially output any code from that code base. Alternatively, under a Mixture of Experts approach, a code base is segmented such that divisions of the model handle different segments of the code base, thus effectively but indirectly restricting generated code to some portion of the code base. The inheritance reconfiguration, by contrast, more directly curates portions of the code base related to the code block needed at any point during code generation. It is best applied at an intermediate loop level, between the prompt and model, as is familiar to those skilled in the art of machine learning.

Various embodiments may automate the process of global DAG construction, making use of information curated from documents or provided in user prompts. Previously disclosed operations that augment a global DAG may be properly ordered by various embodiments. Various embodiments may also make use of previously disclosed generalization operations where an existing entity specialized a newly encountered entity. Various embodiments may also make use of previously disclosed mutating operations including unlinking nodes, cutting or pasting sections of a DAG, or joining two existing nodes with a new association. Splicing operations that insert newly found entities to intermediate positions within a global DAG, such as within a refinement chain, may be implemented primitively or using the above operations.

Various embodiments, especially those that explicitly represent the structure of the localized DAG in the context window, may give the model more specialized training to encourage it to appropriately make use of the localized DAG structure embedded in the query.

### BRIEF DESCRIPTION OF THE DRAWINGS

FIG. 1 is a data flow diagram for an embodiment that satisfies a user prompt related to an entity in a global DAG by reconfiguring the global DAG to a localized DAG to format a context window for querying a model.

FIG. 2 is a data flow diagram for an embodiment that satisfies a user prompt related to an entity added to a global DAG by reconfiguring the global DAG to a localized DAG to format a context window for querying a model.

FIG. 3 is a data flow diagram for an embodiment that augments a global DAG with information from documents.

FIG. 4 is a data flow diagram for an embodiment that trains a model to respond to queries providing a context window containing a localized DAG using test data generated from a global DAG.

FIG. 5 is a data flow diagram for an embodiment that trains a model while augmenting a global DAG with information from documents.

### DETAILED DESCRIPTION

All processes identified in data flow diagrams including four distinguished processes: the user, which may or may not be mechanized; a global DAG; a model; and documents, which may or may not be entirely static, are to be interpreted broadly. Any may be duplicated in various embodiments such that the same or different workloads are shared among them. Any or all may be co-located on the same processing and memory units or dispersed among any number of processing and memory units. Named processes in the diagrams are identified for explanatory purposes only and may not exist as clearly identifiable processes, but rather their responsibilities may be collected by embodiments in various ways, including within distinguished processes. The responsibilities of any process may be performed in various embodiments by direct execution of code intended to have that effect in one or more threads or processes or by any collection of AI models, agents, or harnesses, as is familiar to those skilled in the art of machine learning. Some processes may describe services that various embodiments may choose not to implement, obtaining a reduced set of benefits from the inventions or which may not be needed for an embodiment to reap any or all benefits of the inventions.

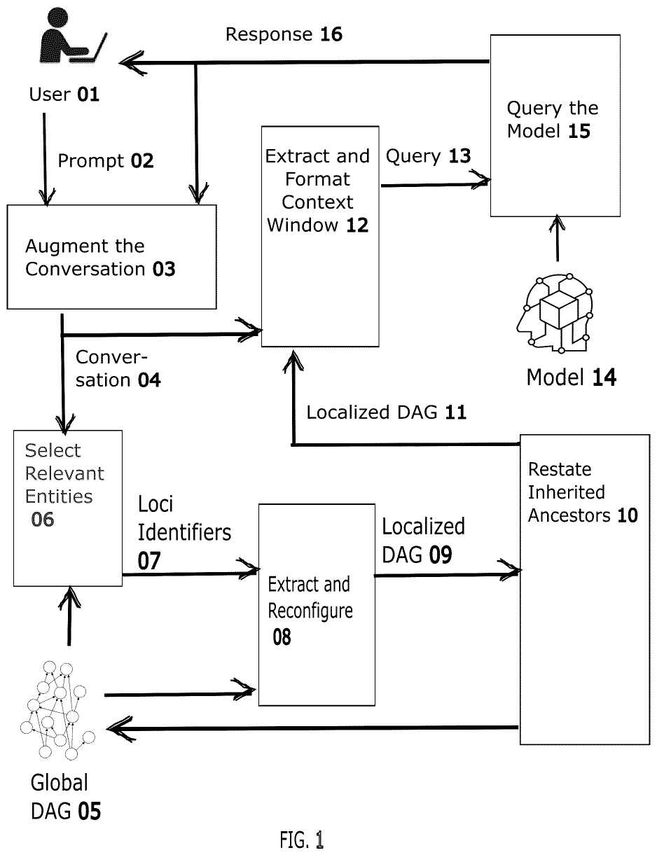

FIG. 1 presents the data flow for an embodiment of the invention. User 01 enters Prompt 02 into the AI system. User 01 may be an individual at a terminal as depicted here, or may be an AI agent. Prompt 02 may include any information potentially associated with one or more entities of the same kind and useful in looking up those entities, including modeling constructs, code, and other forms of auxiliary information, previously disclosed or not. Anticipated Response 16 values may likewise include any information potentially associated with one or more entities of the same kind, including modeling constructs, code, and other forms of auxiliary information, previously disclosed or not. Augment the Conversation 03 may maintain a sequence of Prompt 02 and subsequently received Response 16 values. Conversation 04 may be the entire or some extracted form of that conversation, or just Prompt 02 in the first instance or in a degenerate form of Augment the Conversation 03.

Under various embodiments, Select Relevant Entities 06 makes use of information from Global DAG 05 to select one or more locus entities most relevant to Prompt 02 on the basis of their name or any other attributes and not linearly related to each other, identified by Loci Identifiers 07. This process may be performed in various ways. A simple embodiment might index Global DAG 05 by keywords and lookup entities identified by Loci Identifiers 07, perhaps using a hash table. More robust embodiments would break keywords into syllables, incorporate synonyms, distances in an ontology, or any number of other techniques familiar to those skilled in the art of machine language comprehension. They might also check for presence of keywords within aligned portions of the abstract syntax trees of the prompt versus the stored problem. A still more robust embodiment could also make use of occurrence counts in ancestors or descendants of a potential locus entity, possibly weighted by distance from the potential locus entity. A still more robust embodiment might make use of an artificial intelligence model, within or outside of Model 14, trained to select locus entities from global DAGs such as Global DAG 05. Under various embodiments, such a model could return a single best match, a signal that no match is possible, or a ranked list of possible matches.

Under various embodiments, Prompt 02 may relate to problems in Global DAG 05, and be intended to generate a Response 16 providing additional information about those problems (including auxiliary information or types of code) or describing one or more solutions that solve those problems (including auxiliary information or code). For some of these embodiments, Select Relevant Entities 06 may return Loci Identifiers 07 identifying those problems.

Under various embodiments, Prompt 02 may relate to solutions in Global DAG 05, and be intended to generate a Response 16 providing additional information about those solutions (including auxiliary information or code) or describing one or more problems that decompose those solutions, i.e., specifications of tools that would be helpful in implementing those solutions (including auxiliary information or types of code). For some of these embodiments, Select Relevant Entities 06 may then return Loci Identifiers 07 identifying those solutions.

Throughout this disclosure, prompts of these two forms relating to a space of problems and solutions provide motivation, but other embodiments may instead use other previously disclosed hierarchically structured entity and association types. Furthermore, it should be clear that various embodiments working with problems and solutions may support either one or both of solution associations relating solutions to problems or decomposition associations relating problems to solutions.

Under embodiments supporting code generation, lookup may be influenced by one or more types associated with code, the types being associated with problems and code being associated with solutions. Features of various type systems familiar to those skilled in the art of type theory may be incorporated, including product and coproduct types, universal and existential types, modal types, linear types, dependent types, and type and effect systems (possibly via monads), etc., as would be natural to one skilled in the art of type theory.

Embodiments with Prompt 02 relating to multiple problems may generate a single program that may be executed to deal with any of those problems. Embodiments with Prompt 02 relating to multiple solutions, each not yet associated with any program under some embodiments, may generate a single type or single collection of types such that a single conforming subprogram could be incorporated into the respective program ultimately associated with each of those solutions.

The Loci Identifiers 07 are passed to the Extract and Reconfigure 08 process, which also accesses Global DAG 05, generating Localized DAG 09, using the all or part of the previously disclosed reconfiguration. In particular, various embodiments may merely extract all or selected ancestors and descendants of the locus entities indicated by Loci Identifiers 07, while others will also inherit inheritable entities from a common ancestor with one or more such locus entities to those locus entities. For various embodiments, Localized DAG 09 will be made to include modeling constructs, code, and any other forms of auxiliary information, or references thereto, associated with entities indicated by included nodes and arcs. Embodiments that transform or translate content prior to storing it in Global DAG 05 may well reverse that process upon retrieving the content. As an example of the reconfiguration, under embodiments where a Prompt 02 may relate to one or more problems, Localized DAG 09 may be localized to those problems and those problems may have descendants related to possible solutions and thus responses to Prompt 02, either taken directly from Global DAG 05 in place or inherited by those problems from a refinement ancestor of those problems by action of the reconfiguration. Under embodiments where a Prompt 02 may relate to one or more solutions, for another example, Localized DAG 09 may be localized to those solutions and those solutions may have descendants related to possible decompositions and thus responses to Prompt 02, either taken directly from Global DAG 05 in place or inherited by those solutions from a refinement ancestor of those solutions by action of the reconfiguration.

Response 16, however, should include text specifically referencing Prompt 02, not some generalization of it. For various embodiments, Restate Inherited Ancestors 10 receives Localized DAG 09 and emits Localized DAG 11, an updated version of Localized DAG 09 resulting from the restatement, to Extract and Format Context Window 12. As previously disclosed, the restatement process involves modifying inherited nodes in Localized DAG 09, transforming them to restating nodes that are specialized to the entities represented by Loci Identifiers 07. For various embodiments, these restating nodes indicate new entities in Global DAG 05 that refine the inheritable entities indicated by the inherited nodes as well as refining either locus entities indicated by Loci Identifiers 07 or any entities indicated by restatements of ancestor inherited nodes. Restate Inherited Ancestors 10 may also update Global DAG 05 with the restating entities and associations, avoiding the need for restatement on similar future queries and providing a location for storing any auxiliary information provided via Prompt 02 and specifically relevant to contexts involving the entities identified by Loci Identifiers 07, while for other embodiments it may leave Global DAG 05 unchanged. Various embodiments may not perform Restate Inherited Ancestors 10 explicitly, but rather allow Model 14 to perform the restatement implicitly.

Extract and Format Context Window 12 further extracts from both Conversation 04 and Localized DAG 09 to generate Query 13. The most recent portions of the conversation may be prioritized or earlier significant passages may be prioritized using an attention mechanism as is familiar to those skilled in the art of machine learning. Similarly, various approaches may be used by various embodiments to extract portions of Localized DAG 09. Nodes close to the loci nodes may be prioritized. Context of Localized DAG 09 may be prioritized over substructure (or vice versa). Distant context, being considered a root cause, may be prioritized. Both names of entities and any form of auxiliary information or implementing code stored with respect to entities may be included in Query 13. For various embodiments, Query 13 may contain additional structure or metadata distinguishing portions derived from Conversation 04 from portions derived from Localized DAG 09 and may further maintain the graph structure, association types, forms of auxiliary information, or separation of direct locus from strict context or strict substructure of portions derived from Localized DAG 09.

Query 13 is used by process Query the Model 15 to query Model 14, producing Response 16. Model 14 may or may not be or include a neural network. Response 16 may be returned to User 01 and may be made by process Augment the Conversation 03 to contribute to Conversation 04. Sentiment analysis may be used on Prompt 02 during further iterations of this cycle to further train Model 14 with a limited sequence of instances of Prompt 02 and Response 16 leading up to the analyzed Prompt 02.

At any points in this process, text may be replaced by token representations.

Much of this is familiar to those skilled in the art of machine learning. The innovative step is using selected portions of the global DAG to influence prompt execution, potentially as a basis for a RAG system, and in particular using the previously disclosed process to manipulate the global DAG into a localized DAG that in part determines the contents of the query.

The system, method, and apparatuses described efficiently process user prompts related to hierarchical information by extracting and reconfiguring information from a global DAG. This is useful in of itself, as the global DAG may be constructed by any means including the by a user performing a sequence of augmentation operations as previously disclosed, and the query may be resolved using a standard foundation model not specifically trained regarding any problem and solution or other entity space.

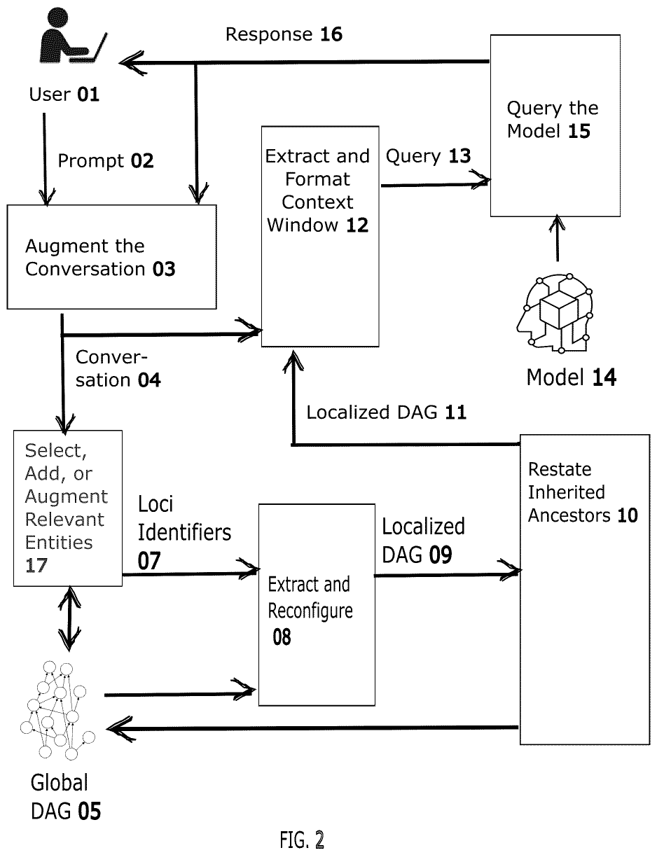

Further benefit can be achieved by automating part or all of the global DAG construction process in cases where the entity relevant to a user prompt does not yet exist in the global DAG. Various enhanced embodiments automatically apply previously disclosed user operations to augment the global DAG based on a user prompt. Some of these embodiments would handle situations where the prompt relates, in whole or in part, to one or more new entities that could be added to Global DAG 05 and regarding which Global DAG 05 may hold some information indirectly that could benefit Response 16. FIG. 2 slightly modifies the data flow of FIG. 1 to account for this situation. Select Relevant Entities 06 is now replaced with Select, Add, or Augment Relevant Entities 17. Under various embodiments, the differences may include creating entities related to Prompt 02 in Global DAG 05 where they did not already exist, or storing content including modeling constructs, code, and any other forms of auxiliary information, or references thereto, with those new or any existing entities, where it was not already present, and including the new identifiers in Loci Identifiers 07. Under various embodiments, any such content may be transformed or translated prior to being stored in Global DAG 05. When it can be determined, perhaps using Conversation 04, that Prompt 02 relates to one or more entities that could be added as refinements of entities already in Global DAG 05, there is benefit to performing that augmentation so as to allow for inheritance of any descendants of refinement ancestors of those entities. For example, where Prompt 02 relates to one or more problems that could be added as refinements of problems already in Global DAG 05, embodiments may allow for inheritance of any solutions of refinement ancestors of those problems. Where Prompt 02 relates to one or more solutions that could be added as refinements of solutions already in Global DAG 05, embodiments may allow for inheritance of any decompositions of refinement ancestors of those solutions. There may also inherently be benefit in growing Global DAG 05 with new information from any source, including User 01's Prompt 02.

It should be clear that some embodiments of this invention may, where the user prompt differs from the contents of the global DAG along multiple dimensions or across a substantial conceptual distance in any single dimension, iterate this approach through multiple steps each applying a primitive operation to Global DAG 05. Various embodiments may attempt to order those operations to maintain a paradigm of augmentation. When faced with an arbitrary sequence of user prompts, however, various embodiments may apply additional primitive operations to make the process more robust.

One such operation would splice an entity into an existing refinement association relating a child entity to a parent entity in Global DAG 05, each of the same kind as the spliced entity, replacing the existing refinement association with a new entity and two new refinement associations, such that the parent entity of the existing refinement association would be a parent entity of the new entity by a new parent refinement association and the child entity of the refinement association would be a child entity of the new entity by a new child refinement association. Various embodiments would leave all other associations ascending or descending from either the parent entity or the child entity in place.

In general, as expressed above, various embodiments may spread processes across various computer systems in different ways. Some embodiments may, in particular regarding the systems illustrated in FIG. 1 and FIG. 2, locate interfaces to User 01 and process Augment the Conversation 03 on a client computer system and spread other processes across one or more server computer systems.

What has been disclosed above is sufficient to obtain the benefits of restricting the context window to information associated with entities relevant to (but not necessarily accessible as ancestors or descendants from) particular locus entities derivable from the user's prompt.

Better results may be obtainable for some embodiments, though, by taking additional steps.

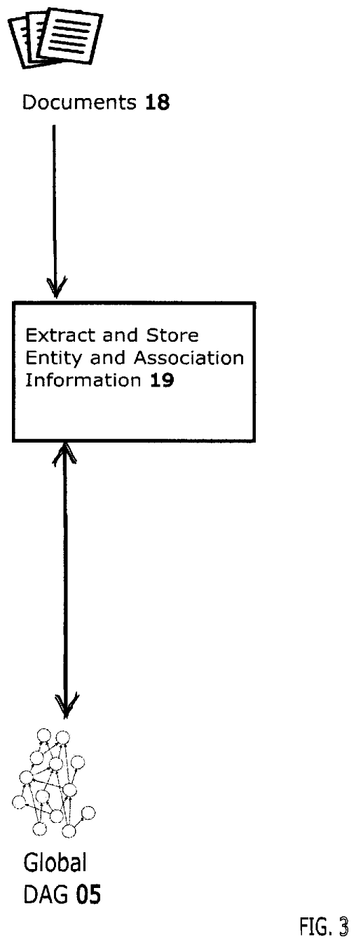

FIG. 3 shows an example embodiment that goes further in building up Global DAG 05 from a collection Documents 18 of documents, via a process Extract and Store Entity and Association Information 19. Documents 18 may include text documents, images, audio or video files, computer programs, computer-aided design (CAD), or any other form of media, any of which may be included or referenced from entities or associations in Global DAG 05 as modeling constructs, code, and any other forms of auxiliary information. In this process, modeling constructs may need to be separated by hierarchical levels of abstraction, as was previously disclosed for Boolean conditions and state machines, among other constructs.

The process could be performed, by various embodiments, all at once or one document at a time. The situation is similar to that of Select, Add, or Augment Relevant Entities 17, a key difference being that that process is restricted to a single user prompt, so various comments there apply here as well. Where nothing relevant is found in Global DAG 05 for an entity mentioned in Documents 18, an entity may be created in isolation, as a new root entity. Where relevant ancestor entities are found, the new entity may be appended using an appropriate association. These augmentations may be applied depth-first or bread-first, or in any other consistent order, as is clear to one skilled in the art of computer algorithms. As was the case with information embedded in user prompts, it may be possible to order primitive operations so as to augment Global DAG 05 top-down, as it might have been built organically. Alternatively, generalization, or splicing or other mutating operations may be used to insert entities in arbitrary order such that a new entity can, for example, take an intermediate position in an existing refinement chain in the Global DAG 05, as described above.

A newly encountered entity may be best approached as a restatement of existing entities, for example a newly encountered solution that elaborates known solutions of a known problem to adapt them to known specializations of the known problem. In such cases, various embodiments may perform the restatement directly on Global DAG 05 or indirectly through a localized DAG (in the example localized to known specializations of the known problem), perhaps constructed for that purpose.

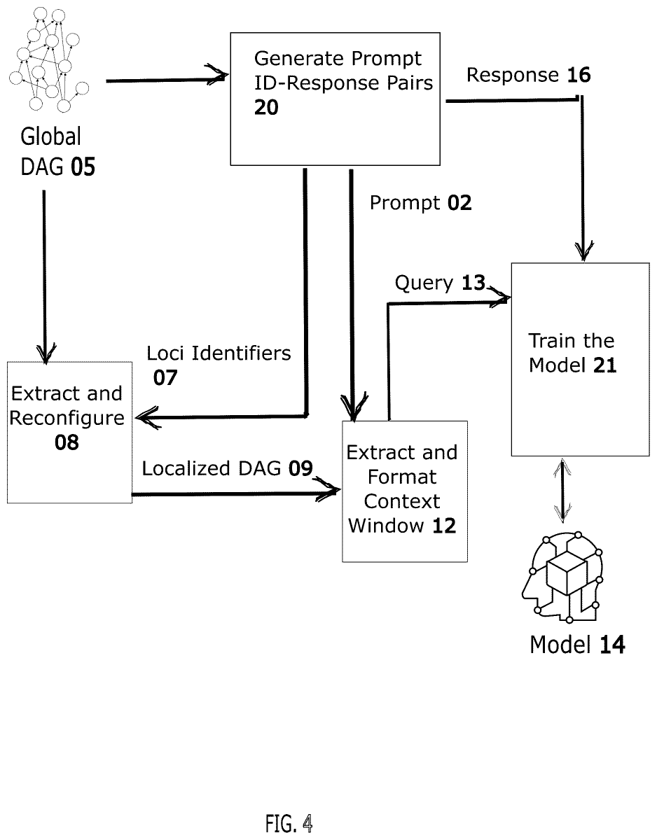

Various embodiments, especially those that explicitly represent the structure of the localized DAG in the context window, may give the model more specialized training to encourage it to appropriately make use of the localized DAG structure embedded in Query 13. We explicitly do not assume that all training need occur before any user queries are resolved, although that will be the case for various embodiments. Various embodiments may attempt to validate the response against any of the artifacts that led to its creation, i.e., against Documents 18 used at any point in constructing Global DAG 05, against Global DAG 05 itself or some portion thereof, or against Localized DAG 09. FIG. 4 shows an embodiment that validates against Global DAG 05. Process Generate Prompt ID-Response Pairs 20 digests Global DAG 05, extracting two collections of related entities, one for the prompt and the other for the response, emitting the identifiers of the former along with the latter. For various embodiments, the process will be similar to that of Extract and Store Entity and Association Information 19, so the comments there will apply, but produces matched pairs of Prompt 02 and Response 16. A problem might be the basis for a prompt and a solution that solves it the basis for a response or a solution might be the basis for a prompt and a problem that decomposes it the basis for a response. The identifiers for the prompt are used by process Extract and Reconfigure 08, described above with respect to querying the model, as Loci Identifiers 07, in applying the previously disclosed reconfiguration. The produced Localized DAG 09 is used by Extract and Format Context Window 12, also described above with respect to querying the model, along with generated Prompt 02, to format a context window, potentially in a customized way. Process Train the Model 21 completes the sequence, informing Model 14 of a connection between Query 13, generated from prompts extracted from Documents 18 and augmented with relevant information drawn from Global DAG 05, and Response 16, also drawn from Documents 18.

Train the Model 21 differs from Query the Model 15 in accepting Response 16 along with Query 13. As is familiar to those skilled in the art of machine learning, the training process generally involves generating a response as in Query the Model 15 and comparing that response against given Response 16, then calculating a difference between them that can be used to update the state of Model 14 so as to arrange that future applications of Query the Model 15 return a response closer, if possible, to Response 16.

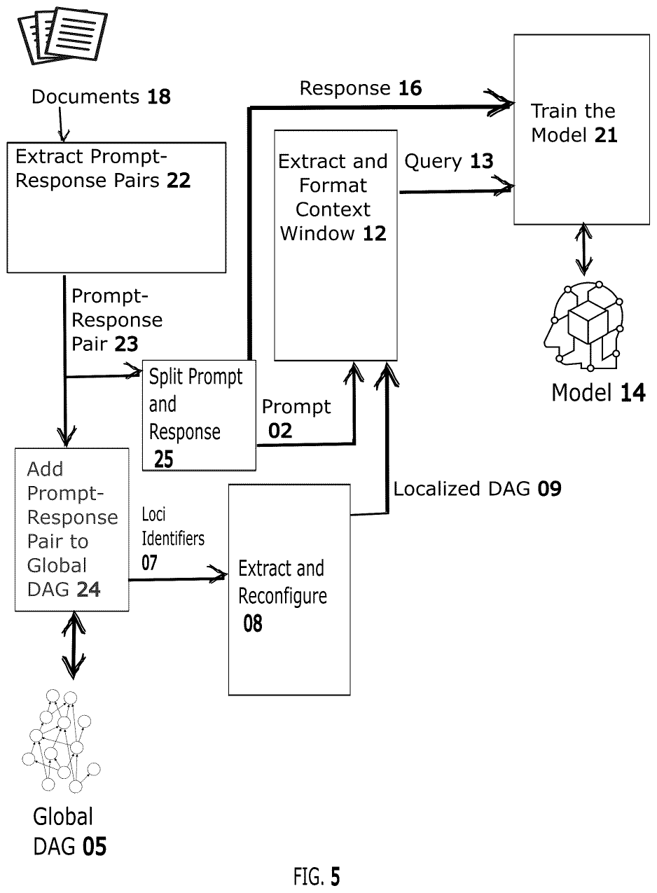

FIG. 5 shows an embodiment that combines the two processes of FIG. 3 and FIG. 4, building up Global DAG 05 from available Documents 18, describing a space of related entities, as part of a process to train Model 14. Extract Prompt-Response Pairs 22 is similar to Generate Prompt ID-Response Pairs 20, but pulls from Documents 18 rather than Global DAG 05, so has no access to IDs Prompt-Response Pair 23 is stored in Global DAG 05 by Add Prompt-Response Pair to Global DAG 24, which is similar to Select, Add, or Augment Relevant Entities 17, but takes its input in one or more matched pairs. Emitted Loci Identifiers 07 are again used by Extract and Reconfigure 08 to generate Localized DAG 09, which along with Prompt 02, split from Prompt-Response Pair 23 by Split Prompt and Response 25, is again encoded in Query 13 by Extract and Format Context Window 12. Train the Model 21 again takes Query 13 from Global DAG 05 and Response 16, split from Prompt-Response Pair 23, also by Split Prompt and Response 25. It should be clear that pairing of prompts and responses is merely a convenience. Various embodiments may consider a calculated response to be a good match to given Response 16 if the latter is included in the former, which, in the space of problems and solutions, may refer to solving solutions/decomposition problems sourced from other documents than Documents 18 or entered into Global DAG 05 in other ways. The approach of FIG. 4 doesn't have that limitation, but the approach shown here has the advantage of relying on original sources.

It should be clear that other ways of combining populating of Global DAG 05 and training of Model 14. Some Documents 18, for example, may be used to populate Global DAG 05 and other documents used to train Model 14, or the same Documents 18 used for both purposes but in processes that occur independently of each other.

1. An apparatus comprising:
a processor-implemented engine; and
memory coupled to the processor-implemented engine, either:
A. the apparatus being distinct from a client, networking hardware supporting the processor-implemented engine in acting as a server communicating with one or more computing devices comprising the client; or
B. the apparatus sharing at least a sub-memory with the client, the memory comprising the sub-memory,
wherein the processor-implemented engine is directed according to instructions stored in the memory to:
a) receive search text relevant to a user prompt from a client;
b) query a global DAG comprising a plurality of entities and a plurality of associations, each association of the plurality of associations relating a child entity and a parent entity of the plurality of entities, receiving in response identification of at least one locus entity of the plurality of entities, receiving in response a respective localized directed acyclic graph (DAG) localized to the at least one locus entity, the respective localized DAG being extracted from the global DAG and reconfigured by applying a reconfiguration, the respective localized DAG being of a plurality of localized DAGs;
c) format part or all of the respective localized DAG as a context window;
d) query a model using the context window;
e) receive a response from the model; and
f) transfer the response to the client,
the respective localized DAG for each at least one locus entity of the plurality of entities comprising:
1) a respective plurality of local entities comprising a constituent entity corresponding to each reachable entity of a plurality of particular reachable entities within the plurality of entities, each reachable entity of the plurality of particular reachable entities being ascended or descended in the global DAG from a respective at least one source locus entity of that at least one locus entity by a respective at least one source path, at least one constituent locus entity of that plurality of locus entities corresponding to that at least one locus entity; and p3 2) a respective plurality of local associations, each local association of the respective plurality of local associations relating a child local entity and a parent local entity of the respective plurality of local entities, the respective plurality of local associations comprising a constituent association corresponding to each association of the plurality of associations on the respective at least one source path for each reachable entity of the plurality of particular reachable entities, that constituent association relating the constituent entity corresponding to the child entity for that association as the child local entity and the constituent entity corresponding to the parent entity for that association as the parent local entity, wherein:
i) the plurality of associations subsumes a plurality of refinement associations, each refinement association of the plurality of refinement associations indicating that the child entity for that refinement association refines the parent entity for that refinement association,
the reconfiguration causing, for each inheritable entity of a respective at least one inheritable entity of the plurality of entities for the at least one locus entity, that inheritable entity being descended in the global DAG from a respective inheritable child entity by a respective inheritable entity path, a respective proper refinement ancestor entity of the plurality of entities being related as a parent in the global DAG to the respective inheritable child entity and being ascended in the global DAG from a respective at least one inheriting locus entity of the respective at least one source locus entity for the respective proper refinement ancestor entity by a respective inheritance path of the respective at least one source path for the respective proper refinement ancestor entity by way of a respective sequence of one or more refinement associations of the plurality of refinement associations, a respective at least one constituent inheriting locus entity of the at least one constituent locus entity corresponding to the respective at least one inheriting locus entity for that inheritable entity, a deep inheritable entity of the respective at least one inheritable entity not being the respective inheritable child entity:
where that inheritable entity is a non-locus-descended inheritable entity that is not descended in the global DAG from any locus entity of the at least one locus entity:
I) the respective plurality of local entities for the at least one locus entity to comprise a respective inherited entity corresponding to the non-locus-descended inheritable entity; and
II) the respective plurality of local associations for the at least one locus entity to comprise, for each of the respective at least one inheriting locus entity for that inheritable entity, a respective inheriting association with the respective inherited entity corresponding to the non-locus-descended inheritable entity as the child local entity and with the constituent entity corresponding to that inheriting locus entity being ascended in the respective localized DAG for the at least one locus entity from the parent local entity; and
where the plurality of entities comprises a noninheritable entity that is not indicated by any local entity of the plurality of local entities,
whereby supporting the client in enabling a user to converse with the model with the benefit of information from the global DAG, the context window containing information related to the non-locus-descended inheritable entity but not containing information related to the noninheritable entity.
